(19) United States
(12) Patent Application Publication
(10) Pub. No.: US 2022/0065475 A1
(43) Pub. Date: Mar. 3, 2022

(54) HEATWAVE RISK CALCULATION SYSTEM

(71) Applicant: JEONJU UNIVERSITY INDUSTRY ACADEMY COOPERATION CORPS., Jeollabuk-do (KR)

(72) Inventors: Dae Sung Jeon, Iksan-si (KR); Dong-Hyuk Im, Cheonan-si (KR); Jinhyun Ahn, Jeju-si (KR)

(73) Assignee: JEONJU UNIVERSITY INDUSTRY ACADEMY COOPERATION CORPS., Jeollabuk-do (KR)

(21) Appl. No.: 17/010,865

(22) Filed: Sep. 3, 2020

(30) Foreign Application Priority Data
Aug. 25, 2020 (KR) 10-2020-0107008

(51) Int. Cl. F24F 11/30; G06F 17/11

(52) U.S. Cl. CPC F24F 11/30; F24F 2110/10; G06F 17/11

(57) ABSTRACT

An embodiment of the present invention may provide a heatwave risk calculation system including: an external data receiving unit for receiving external data; a building-base database generation unit for calculating energy vulnerability of each building by using the received external data; a heatwave vulnerable class determination unit for calculating a heatwave risk of each building by using the energy vulnerability of each building; and a display unit for displaying the determined vulnerable class on a map.

### BACKGROUND OF THE INVENTION

### Field of the Invention

The present invention relates to a heatwave risk calculation system, and more specifically, to a heatwave risk calculation system, which calculates a heatwave risk through energy vulnerability of each building.

### Background of the Related Art

Heatwaves are differently defined in different regions since people's adaptability varies according to climate zones. Since definition of heatwave has an absolute standard and a relative standard, they are selectively used.

In the case of Korea's Meteorological Administration, when a day in which the maximum daily temperature is 33 degrees Celsius or higher in the middle of the day is expected to last for two days or more, a ‘heatwave advisory’ is issued, and when a day above 35 degrees Celsius or higher is expected to last for two days or more, a ‘heatwave warning’ is issued. In China, the standard is 35 degrees Celsius, which is higher than that of Korea, and the United States selects a heat index considering humidity as well as temperature. Since definition of heatwave varies depending on the region, there is a method of defining the heatwave on the basis of a relative standard. Based on the statistical distribution of all the highest daily temperatures observed before in a region, a temperature corresponding to the 90th percentile value, the 95th percentile value or the like is used as a boundary value of heatwave standard.

Unlike other weather disasters, heatwaves are dangerous since they directly affect human bodies. The human bodies are vulnerable to both high temperature and high humidity conditions. When the temperature rises, the human body lowers the body temperature through evaporation of sweat, and when the relative humidity in the air is high or close to saturation, the sweat cannot be evaporated smoothly, and people feel relatively hotter in a high humidity state. A heat disease occurs when the temperature and humidity soar as the heatwave occurs. For example, the hypothalamus gland, which regulates heat in the brain, allows a person to sweat up to two liters per hour, and as the sweat evaporates, it rapidly reduces water and salt in the body and causes a chemical imbalance state, and heat cramping occurs. Sweating a lot may accompany fatigue, headache, nausea, fainting or the like. When the body temperature rises above 41 degrees Celsius (106 degrees Fahrenheit), it may lead to death with heatstroke that completely paralyzes the circulatory system.

The U.S. Meteorological Administration selects a heat index in consideration of temperature and humidity to indicate a risk. As the heatwave monitoring system currently in operation predicts and announces temperatures in a wide area, there is a problem in that it is difficult to adequately respond to occurrence of local heatwaves according to urbanization.

It urgently needs to develop a realistic and accurate heatwave index calculation and prediction model, and the efforts for preventing administrative costs and other social losses are continued to cope with heatwaves.

Prior document: Korean Patent Registration No. 10-1841217

In the prior document, based on weather observation big data about the temperatures perceived in the places such as roads, parks, rivers, residential areas, playgrounds and the like in cities, an index for issuing a heatwave warning for each land cover map, which can be felt by citizens, is developed for the sake of health protection of vulnerable classes, and an urban micro-space heatwave index calculation system of applying weighting values of radiation convection temperature and relative humidity is disclosed to suggest heatwave countermeasures that can be put into practice by citizens.

### SUMMARY OF THE INVENTION

Therefore, the present invention has been made in view of the above problems, and it is an object of the present invention to provide a technique of calculating energy vulnerability by the unit of building, calculating a heatwave risk based on the energy vulnerability, and displays the heatwave risk.

To accomplish the above object, according to one aspect of the present invention, there is provided a heatwave risk calculation system comprising: an external data receiving unit for receiving external data; a building-base database generation unit for calculating energy vulnerability of each building by using the received external data; a heatwave vulnerable class determination unit for calculating a heatwave risk of each building by using the energy vulnerability of each building; and a display unit for displaying the determined vulnerable class on a map.

The external data received by the external data receiving unit may include a floating population of a specific area, a construction year of each building in the specific area, energy consumption of each building in the specific area, and average energy consumption of all households.

The heatwave vulnerable class determination unit may determine a heatwave vulnerable class by linking a temperature of each building and the heatwave risk of each building, and a temperature measured at a weather station nearest from a building may be calculated as the temperature of each building.

### BRIEF DESCRIPTION OF THE DRAWINGS

FIG. 1 is a block diagram showing the configuration of a heatwave risk calculation system according to an embodiment of the present invention.

FIG. 2 is a view showing a form of data stored in a building-base database generation unit in a heatwave risk calculation system according to an embodiment of the present invention.

FIG. 3 is a flowchart illustrating a heatwave risk calculation method according to another embodiment of the present invention.

FIG. 4 is a view illustrating a flow of a heatwave risk display method according to still another embodiment of the present invention.

FIG. 5 is a view illustrating a flow of a heatwave risk display method according to still another embodiment of the present invention.

### DESCRIPTION OF SYMBOLS

110: External data receiving unit
120: Building-base database generation unit
130: Heatwave vulnerable class determination unit
140: Display unit

### DETAILED DESCRIPTION OF THE PREFERRED EMBODIMENT

Hereinafter, the present invention will be described in detail with reference to the drawings.

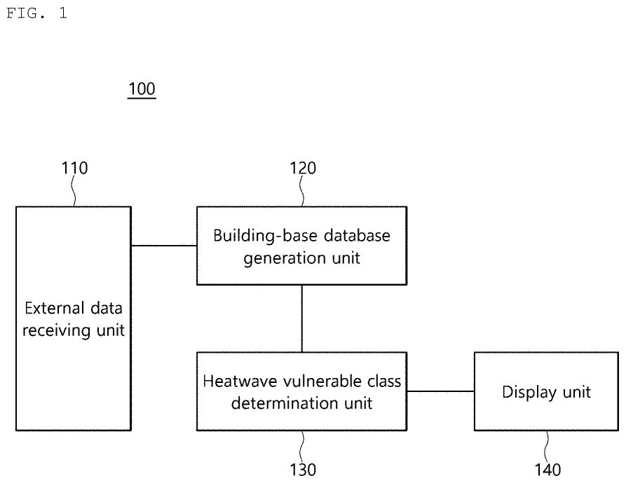

FIG. 1 is a block diagram showing the configuration of a heatwave risk calculation system according to an embodiment of the present invention.

The heatwave risk calculation system 100 according to the present embodiment may include an external data receiving unit 110, a building-base database generation unit 120, a heatwave vulnerable class determination unit 130, and a display unit 140. The heatwave risk calculation system 100 according to the present embodiment may calculate a heatwave risk by using building information in a specific area and energy consumption of each building. Since the heatwave risk calculation system 100 according to the present embodiment calculates a heatwave risk in a specific area, it may use basic geographic information of the buildings in the specific area.

The external data receiving unit 110 may receive external data. Here, the external data may include floating population of a specific area, construction year of each building in the specific area, energy consumption of each building in the specific area, and average energy consumption of all households. The external data receiving unit 110 according to the present embodiment may receive the external data through user's data input. In addition, the external data receiving unit 110 according to the present embodiment may receive the data from the outside using wireless or wired communication. As described, the receiving method of the external data receiving unit 110 may be implemented in various ways according to the nature of input data or an input method.

The floating population data may be data obtained by dividing a specific area into a plurality of cells and measuring changes in population among the cells. The floating population data may use location data of mobile communication terminals of a mobile communication company. The floating population data used in this embodiment is not an actual floating population of each building, but a floating population data of a cell closest to the location of each building may be used as the floating population data of each building. In this embodiment, daily and monthly data may be received as the floating population data, and daily average floating population data and monthly average floating population data may be secured.

The construction year of each building may be a construction year data of a building. The construction year data of a building is recorded in the land register, a certified copy of a building register or the like. In the heatwave risk calculation system according to the present embodiment, the construction year data of each building may be received through the external data receiving unit 110.

The energy consumption of each building and the average energy consumption of all households may be electricity consumption measured for each building and average electricity consumption of all households in a specific area. Data on the power measured by Korea Electric Power Corporation (KEPCO) may be used as the electricity consumption data. Both daily and monthly data of the electricity consumption may be obtained. In addition, even electricity consumption per hour may also be measured and received. As for the construction year data of each building, reception of the data may be completed by one-time data input since data that has been inputted once will not be changed, whereas as for the energy consumption of each building, continuous reception and storage of data may be required since the data changes every hour, day, and month. When continuous data reception is required like this, it is preferable that the data receiving unit receives the data through wireless communication or wired communication.

The building-base database generation unit 120 may calculate energy vulnerability of each building by using the received external data. In this embodiment, the floating population of a specific area, the construction year of each building in the specific area, the energy consumption of each building in the specific area, and the average energy consumption of all households may be used as the external data. The energy vulnerability of each building may be calculated by Equation 1 shown below by using the external data received in this way.

Energy vulnerability=a·((Average energy consumption of all households−Energy consumption of corresponding building)/Floating population)+b·Construction year of building [Equation 1]

Here, a and b are weighting values, and a+b=1.

The average energy consumption of all households may be average consumption of power used by all households in a specific area. The energy consumption of a corresponding building may be consumption of power used by a corresponding building in a specific area. The consumption of power may be consumption of power used per day, consumption of power used per month, or consumption of power used per hour. The floating population may be a data obtained by dividing a specific area into a plurality of cells and measuring changes in population among the cells. The location data of mobile communication terminals of a mobile communication company may be used as the floating population data. The floating population used in the energy vulnerability calculation equation is not an actual floating population of each building, but a floating population data of a cell closest to the location of a corresponding building may be used as the floating population data of each building. Since the electricity consumption will increase when there are many residents actually living in a corresponding area, the energy consumption is divided by the floating population for the purpose of a relative comparison of electricity consumption.

The energy vulnerability used in this embodiment may indicate how much less energy a specific building uses than other buildings in consideration of energy consumption of the building, the construction year of the building, and the floating population in the nearby area. The less the energy is used than the average of all households and the older the building is, the greater the energy vulnerability will be.

As described above, the heatwave risk calculation system according to the present embodiment uses the energy vulnerability to calculate a heatwave risk. When the heatwave continues, electricity consumption generally increases as the use of air conditioners increases. It may be assumed that buildings that use less electricity than the average electricity used in a specific area despite the heatwave do not normally operate air conditioners. The reason of not operating the air conditioners may be that there are no people in the buildings, or they do not operate the air conditioners deliberately to save electricity. In this embodiment, the buildings that consume less electricity than the average electricity consumption in the area are primarily estimated as an energy vulnerable class, and floating population data is used to compensate for the low electricity consumption due to the vacancy of the building. In addition, the reason of using the construction year of a building in determining the energy vulnerability is that it may be generally assumed that the older a building is, installation of air conditioners is insufficient.

In the heatwave risk calculation system according to the present embodiment, the building-base database generation unit 120 stores the floating population of a specific area, the construction year of each building in the specific area, the energy consumption of each building in the specific area, and the average energy consumption of all households, and in addition, energy vulnerability calculated from the data may be stored in a database.

The heatwave vulnerable class determination unit 130 may calculate a heatwave risk of each building by using the energy vulnerability of each building.

In this embodiment, the heatwave risk may be calculated by Equation 2 shown below.

Heatwave risk=c·Energy vulnerability+d·Accessibility to a medical institution [Equation 2]

Here, c and d are weighting values, and c+d=1.

The heatwave risk may be calculated based on the energy vulnerability and the accessibility to a medical institution calculated in Equation 1. The accessibility to a medical institution may be calculated using geographic information. The accessibility to a medical institution may include how close a building is to a medical institution and how long it takes to transfer a patient from the building to the medical institution.

Specifically, the accessibility to a medical institution may be calculated by Equation 3 shown below.

Accessibility to medical institution=e·Distance to nearest medical institution+f·Number of chronic and illegal parking and stopping zones on a path [Equation 3]

Here, e and f are weighting values, and e+f=1.

The accessibility to a medical institution may be calculated based on the distance from a building to a nearest medical institution and the number of chronic and illegal parking and stopping zones that obstruct traffic flow on the path between the building and the medical institution.

The distance between a specific building and a medical institution, and the number of chronic and illegal parking and stopping zones in the path may be calculated based on geographic information. Since such geographic information forms an important part of the heatwave risk calculation system according to the present embodiment, basic constituents of the geographic information may be embedded in the system, or the geographic information may be fetched by connecting to a server that provides various geographic information.

The heatwave risk is calculated for each building in a specific area, and the higher the heatwave risk value, the more vulnerable the building is to the heatwave. The heatwave vulnerable class determination unit 130 may determine buildings with a high heatwave risk in a specific area as the heatwave vulnerable class. As for the criteria for determining buildings of high heatwave risk, various criteria may be selected, such as selecting a building with a heatwave risk higher than the average heatwave risk of all buildings, selecting a building within the top 10% of the heatwave risk of all buildings, and the like.

In the heatwave risk calculation system according to the present embodiment, the heatwave vulnerable class determination unit 130 may determine a heatwave vulnerable class by linking the temperature of each building with the heatwave risk. As for the temperature of each building, a temperature measured at a weather station nearest from a building may be determined as the temperature of the building. At this point, the distance from the building to the nearest weather station may be calculated by the Euclidean measurement method. In addition, an average of the temperatures measured at two or more weather stations nearest from the building may be calculated as the temperature of the building. For example, when a temperature measured at a first weather station nearest from a specific building is 33.2° C. and a temperature measured at a second weather station that is second nearest from the building is 33.6° C., the temperature of the specific building may be 33.4° C. In this way, when the temperature of a specific building exceeds a temperature determined as a heatwave (for example, 33° C.), a heatwave vulnerable class may be determined by linking the temperature of the building with the calculated heatwave risk. In this way, when the temperature of a building is linked, an actual heatwave risk may be determined compared to a case of simply determining the heatwave vulnerable class based only on the energy vulnerability and accessibility to a medical institution.

In this way, in order to determine a heatwave vulnerable class by linking temperatures, the external data receiving unit 110 may receive temperature information from a weather station arranged in each region. The received temperature information may be mixed with geographic information and stored in the building-base database generation unit 120. The building-base database generation unit 120 may generate and store temperature information of each building by using measurement information of a weather station located near the building.

The display unit 140 may display the matters determined by the heatwave vulnerable class determination unit 130 on a map. The map used herein may use an external geographic information providing server. For example, a heatwave risk of each building may be calculated and visualized to be displayed as a graph or a picture on a map of a specific area. In addition, buildings corresponding to a heatwave vulnerable class may be displayed on the display screen to be easily identified through additional colors or markings so that the buildings determined as a heatwave vulnerable class may be compared with other buildings.

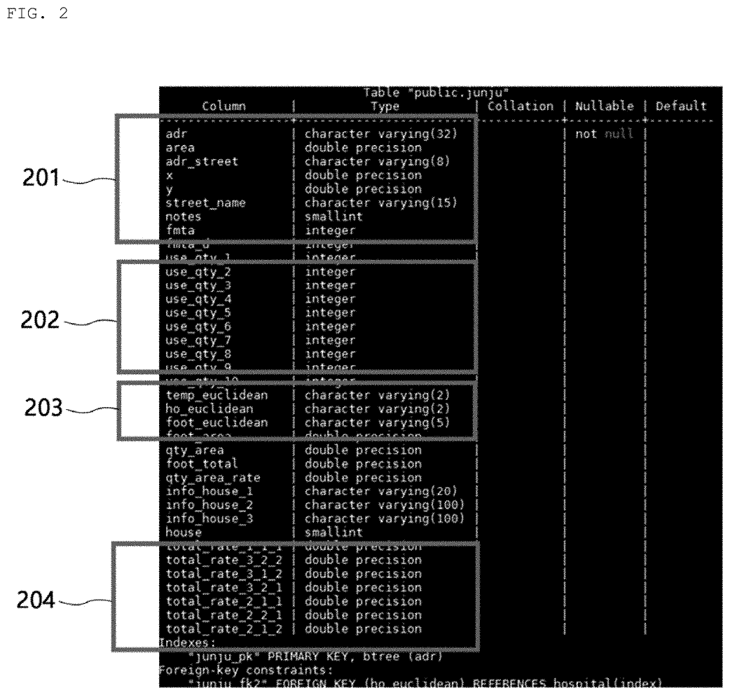

FIG. 2 is a view showing an example of a database generated by a building-base database generation unit in a heatwave risk calculation system according to an embodiment of the present invention.

Referring to FIG. 2, the database generated in the building-base database generation unit according to the present embodiment may include building information 201, electricity consumption information 202, temperature and floating population information 203, weighting value-added information 204, and the like.

The building information 201 may include building address (adr), building area (area), road name address (adr_street), building's coordinate system (x,y), building's construction year (FTMA), and the like. The electricity consumption information 202 may include electricity consumption of each month (use_qty_1 to 10). The temperature and floating population information 203 may include a temperature measured at a weather station nearest from the building (temp_euclidean), which is calculated using the Euclidean distance formula, a hospital number of a nearest hospital (ho_euclidean), data on the floating population in the nearby area (foot_euclidean), and the like. The weighting value-added information 204 may include values (total rate) obtained by applying an addition value to each score of electricity consumption per area, temperature, and floating population.

In addition, the database may include information such as a data (qty_area) obtained by calculating electricity consumption per area of a building, whether it is a house (house), and the like.

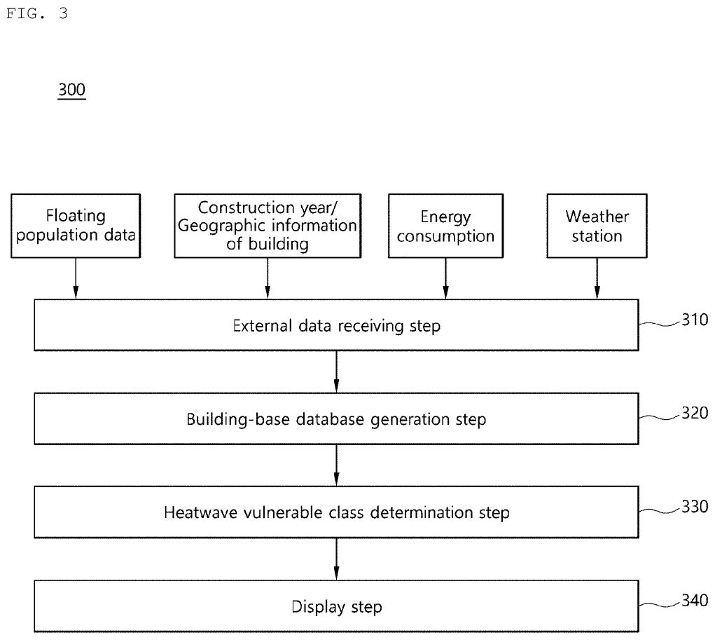

FIG. 3 is a flowchart illustrating a heatwave risk calculation method according to another embodiment of the present invention.

The heatwave risk calculation method 300 according to the present embodiment may include an external data receiving step 310, a building-base database generation step 320, a heatwave vulnerable class determination step 330, and a display step 340. The heatwave risk calculation method 300 according to the present embodiment may calculate a heatwave risk by using building information of a specific area and energy consumption of each building. Since the heatwave risk calculation method 300 according to the present embodiment calculates the heatwave risk of a specific area, it may use basic geographic information about buildings in the specific area.

The external data receiving step 310 may receive external data. Here, the external data may include the floating population of a specific area, the construction year of each building in the specific area, geographic information indicating the location of the building, energy consumption of each building in the specific area, the average energy consumption of all households, observation information of a weather station, and the like. At the external data receiving step 310 according to the present embodiment, the external data may be received through user's data input. In addition, at the external data receiving step 310 according to the present embodiment, data may be received from the outside using wireless or wired communication. As described, the receiving method at the external data receiving step 310 may be implemented in various ways according to the nature of input data or an input method.

The floating population data may be data obtained by dividing a specific area into a plurality of cells and measuring changes in population among the cells. The floating population data may use location data of mobile communication terminals of a mobile communication company. The floating population data used in this embodiment is not an actual floating population of each building, but a floating population data of a cell closest to the location of each building may be used as the floating population data of each building. In this embodiment, daily and monthly data may be received as the floating population data, and daily average floating population data and monthly average floating population data may be secured.

The construction year of each building may be a construction year data of a building. The construction year data of a building is recorded in the land register, a certified copy of a building register or the like. In addition, geographical information of each building may be obtained, in addition to the construction year of the building.

The energy consumption of each building and the average energy consumption of all households may be electricity consumption measured for each building and average electricity consumption of all households in a specific area. Data on the power measured by Korea Electric Power Corporation (KEPCO) may be used as the electricity consumption data. Both daily and monthly data of the electricity consumption may be obtained. In addition, even electricity consumption per hour may also be measured and received. As for the construction year data of each building, reception of the data may be completed by one-time data input since data that has been inputted once will not be changed, whereas as for the energy consumption of each building, continuous reception and storage of data may be required since the data changes every hour, day, and month. When continuous data reception is required like this, it is preferable that the data is received at the data receiving step through wireless communication or wired communication.

At the building-base database generation step 320, energy vulnerability of each building may be calculated by using the received external data. In this embodiment, the floating population of a specific area, the construction year of each building in the specific area, the energy consumption of each building in the specific area, and the average energy consumption of all households may be used as the external data. The energy vulnerability of each building may be calculated by Equation 1 shown below by using the external data received in this way.

Energy vulnerability=a·((Average energy consumption of all households−Energy consumption of corresponding building)/Floating population)+b·Construction year of building [Equation 1]

Here, a and b are weighting values, and a+b=1.

The average energy consumption of all households may be average consumption of power used by all households in a specific area. The energy consumption of a corresponding building may be consumption of power used by a corresponding building in a specific area. The consumption of power may be consumption of power used per day, consumption of power used per month, or consumption of power used per hour. The floating population may be a data obtained by dividing a specific area into a plurality of cells and measuring changes in population among the cells. The location data of mobile communication terminals of a mobile communication company may be used as the floating population data. The floating population used in the energy vulnerability calculation equation is not an actual floating population of each building, but a floating population data of a cell closest to the location of a corresponding building may be used as the floating population data of each building. Since the electricity consumption will increase when there are many residents actually living in a corresponding area, the energy consumption is divided by the floating population for the purpose of a relative comparison of electricity consumption.

The energy vulnerability used in this embodiment may indicate how much less energy a specific building uses than other buildings in consideration of energy consumption of the building, the construction year of the building, and the floating population in the nearby area. The less the energy is used than the average of all households and the older the building is, the greater the energy vulnerability will be.

As described above, at the heatwave risk calculation system according to the present embodiment, the energy vulnerability is used to calculate a heatwave risk. When the heatwave continues, electricity consumption generally increases as the use of air conditioners increases. It may be assumed that buildings that use less electricity than the average electricity used in a specific area despite the heatwave do not normally operate air conditioners. The reason of not operating the air conditioners may be that there are no people in the buildings, or they do not operate the air conditioners deliberately to save electricity. In this embodiment, the buildings that consume less electricity than the average electricity consumption in the area are primarily estimated as an energy vulnerable class, and floating population data is used to compensate for the low electricity consumption due to the vacancy of the building. In addition, the reason of using the construction year of a building in determining the energy vulnerability is that it may be generally assumed that the older a building is, installation of air conditioners is insufficient.

In the heatwave risk calculation method according to the present embodiment, at the building-base database generation step 320, the floating population of a specific area, the construction year of each building in the specific area, the energy consumption of each building in the specific area, and the average energy consumption of all households are stored, and in addition, energy vulnerability calculated from the data may be stored in a database.

At the heatwave vulnerable class determination step 330, a heatwave risk of each building may be calculated by using the energy vulnerability of each building.

In this embodiment, the heatwave risk may be calculated by Equation 2 shown below.

Heatwave risk=c·Energy vulnerability+d·Accessibility to a medical institution [Equation 2]

Here, c and d are weighting values, and c+d=1.

The heatwave risk may be calculated based on the energy vulnerability and the accessibility to a medical institution calculated in Equation 1. The accessibility to a medical institution may be calculated using geographic information. The accessibility to a medical institution may include how close a building is to a medical institution and how long it takes to transfer a patient from the building to the medical institution.

Specifically, the accessibility to a medical institution may be calculated by Equation 3 shown below.

Accessibility to medical institution=e·Distance to nearest medical institution+f·Number of chronic and illegal parking and stopping zones on a path [Equation 3]

Here, e and f are weighting values, and e+f=1.

The accessibility to a medical institution may be calculated based on the distance from a building to a nearest medical institution and the number of chronic and illegal parking and stopping zones that obstruct traffic flow on the path between the building and the medical institution.

The distance between a specific building and a medical institution, and the number of chronic and illegal parking and stopping zones in the path may be calculated based on geographic information. Since such geographic information forms an important part of the heatwave risk calculation system according to the present embodiment, basic constituents of the geographic information may be embedded in the system, or the geographic information may be fetched by connecting to a server that provides various geographic information.

The heatwave risk is calculated for each building in a specific area, and the higher the heatwave risk value, the more vulnerable the building is to the heatwave. At the heatwave vulnerable class determination step 330, buildings with a high heatwave risk in a specific area may be determined as the heatwave vulnerable class. As for the criteria for determining buildings of high heatwave risk, various criteria may be selected, such as selecting a building with a heatwave risk higher than the average heatwave risk of all buildings, selecting a building within the top 10% of the heatwave risk of all buildings, and the like.

In the heatwave risk calculation method according to the present embodiment, at the heatwave vulnerable class determination step 330, a heatwave vulnerable class may be determined by linking the temperature of each building with the heatwave risk. As for the temperature of each building, a temperature measured at a weather station nearest from a building may be determined as the temperature of the building. At this point, the distance from the building to the nearest weather station may be calculated by the Euclidean measurement method. In addition, an average of the temperatures measured at two or more weather stations nearest from the building may be calculated as the temperature of the building. For example, when a temperature measured at a first weather station nearest from a specific building is 33.2° C. and a temperature measured at a second weather station that is second nearest from the building is 33.6° C., the temperature of the specific building may be 33.4° C. In this way, when the temperature of a specific building exceeds a temperature determined as a heatwave (for example, 33° C.), a heatwave vulnerable class may be determined by linking the temperature of the building with the calculated heatwave risk. In this way, when the temperature of a building is linked, an actual heatwave risk may be determined compared to a case of simply determining the heatwave vulnerable class based only on the energy vulnerability and accessibility to a medical institution.

In this way, in order to determine a heatwave vulnerable class by linking temperatures, at the external data receiving step 310, temperature information may be received from a weather station arranged in each region. The received temperature information may be mixed with geographic information and stored in the building-base database generation unit 120. At the building-base database generation step 320, temperature information of each building may be generated and stored by using measurement information of a weather station located near the building.

At the display step 340, the matters determined at the heatwave vulnerable class determination step 330 may be displayed on a map. The map used herein may use an external geographic information providing server. For example, a heatwave risk of each building may be calculated and visualized to be displayed as a graph or a picture on a map of a specific area. In addition, buildings corresponding to a heatwave vulnerable class may be displayed on the display screen to be easily identified through additional colors or markings so that the buildings determined as a heatwave vulnerable class may be compared with other buildings.

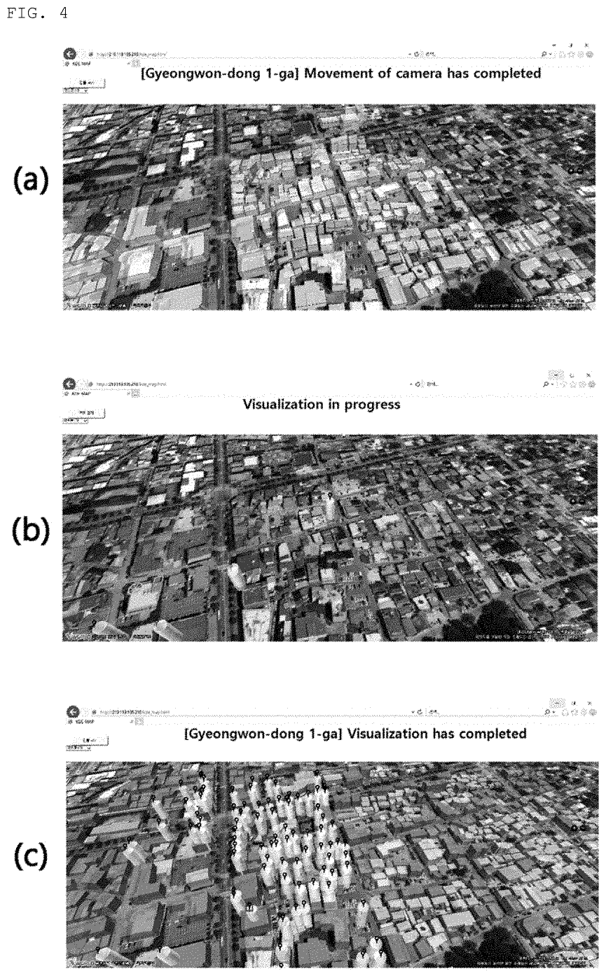

FIG. 4 is a view showing a heatwave risk display method according to another embodiment of the present invention.

Referring to FIG. 4(a), a user who uses the heatwave risk calculation system may specify an area for which a heatwave risk is desired to be calculated on the display. In this example, ‘Gyeongwon-dong 1-ga’ is specified. For the specified area, the heatwave risk calculation system may calculate energy vulnerability by using energy consumption and building history information of each building in the area, and calculate a heatwave risk of each building in consideration of the energy vulnerability and accessibility to a medical institution.

FIG. 4(b) shows a process of displaying a heatwave vulnerable class on a map according to the heatwave risk calculated by the heatwave risk calculation system. In this embodiment, a heatwave risk is calculated for each building within a specified area, and buildings with a heatwave risk higher than an average heatwave risk in the area are displayed in a cylindrical shape. Therefore, buildings marked as a cylinder on the display are heatwave vulnerable classes. In this drawing, information on some of the buildings in the area is displayed.

FIG. 4(c) shows a state in which calculation of a heatwave risk and display of buildings with a high heatwave risk are completed in the heatwave risk calculation system. Although buildings with a heatwave risk higher than the average heatwave risk within an area are uniformly displayed in a cylindrical shape in this embodiment, the sizes or the colors of the cylinders may be different as the heatwave risk increases when the quantitative value of the heatwave risk is reflected. For example, the display for enhancing the visibility of system users may be implemented in various ways such as displaying the buildings within the top 10% of the heatwave risk in the entire area in red, and displaying the buildings within the top 10 to 30% of the heatwave risk in pink. In addition, it may be implemented to display the height of the cylinder to be different according to the quantitative value of the heatwave risk, and the quantitative value may be displayed as a number.

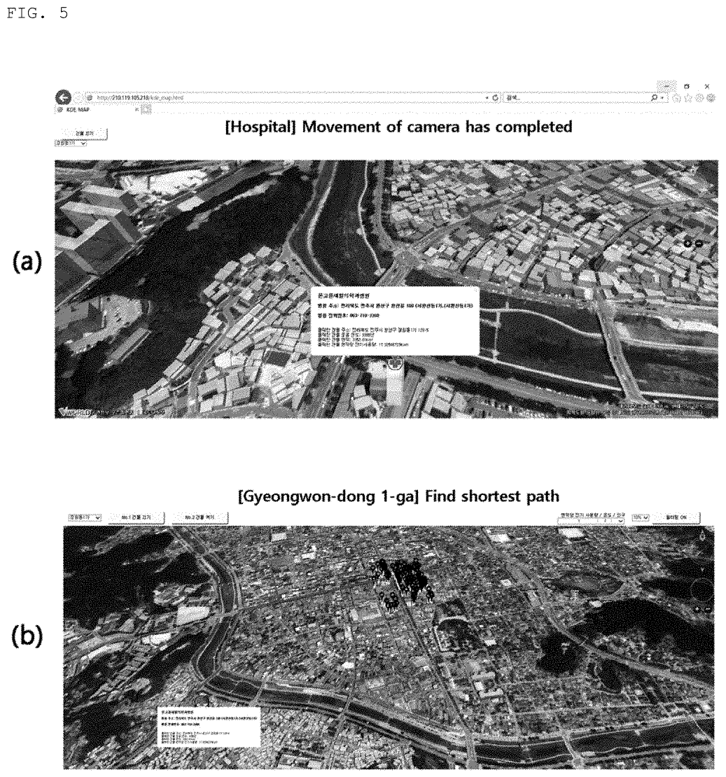

FIG. 5 is a view showing a heatwave risk display method according to still another embodiment of the present invention. In the heatwave risk display method according to the present embodiment, when a building with a high heatwave risk is selected on the screen, a medical institution nearest from the building is displayed, and an optimal traffic path from the building to the medical institution may be displayed.

As described above with reference to FIG. 4, in the heatwave risk display method according to the present embodiment, a building with a high heatwave risk may be displayed on the screen. From an administrative point of view, additional actions may be required after identifying buildings with a high heatwave risk.

Referring to FIG. 5(a), in the display method according to the present embodiment, when a building with a high heatwave risk identified in FIG. 4 is specified (clicked), the location of a hospital nearest from the building may be displayed. The location information of the hospital may be obtained by utilizing geographic information. In the heatwave risk display method according to the present embodiment, information on the hospital nearest from the building may be displayed on the screen after the geographic location of the building is specified.

Referring to FIG. 5(b), in the display method according to the present embodiment, a traffic path from the building to the hospital may be displayed. At this point, the traffic path display may be linked with a navigation system to find an optimal path by reflecting real-time traffic information as well as the geographic information.

According to the present invention, energy vulnerability may be calculated by the unit of building, and a heatwave risk of each building may be calculated through the energy vulnerability. As the heatwave risk is calculated for each building in this way, it is possible to review preemptive welfare administration or the like for heatwave vulnerable classes.

Although it has described above with reference to preferred embodiments and examples of the present invention, it may be understood that those skilled in the art may variously modify and change the present invention without departing from the spirit and scope of the present invention described in the following claims. For example, the building-base database may be processed more diversely, and the display types of each building according to the heatwave risk may be implemented diversely. These modified implementations should not be individually understood from the technical spirit or perspective of the present invention.

What is claimed is:

1. A heatwave risk calculation system comprising:
an external data receiving unit for receiving external data;
a building-base database generation unit for calculating energy vulnerability of each building by using the received external data;
a heatwave vulnerable class determination unit for calculating a heatwave risk of each building by using the energy vulnerability of each building; and
a display unit for displaying the determined vulnerable class on a map.

2. The system according to claim 1, wherein the external data received by the external data receiving unit includes a floating population of a specific area, a construction year of each building in the specific area, energy consumption of each building in the specific area, and average energy consumption of all households.

3. The system according to claim 2, wherein the energy vulnerability is calculated by an equation shown below.
Energy vulnerability=a·((Average energy consumption of all households−Energy consumption of corresponding building)/Floating population)+b·Construction year of building
(a and b are weighting values, and a+b=1)

4. The system according to claim 3, wherein in the heatwave vulnerable class determination unit, the heatwave risk is calculated by an equation shown below.
Heatwave risk=c·Energy vulnerability+d·Accessibility to a medical institution
(c and d are weighting values, and c+d=1)

5. The system according to claim 4, wherein accessibility to a hospital is calculated by an equation shown below.
Accessibility to medical institution=e·Distance to nearest medical institution+f·Number of chronic and illegal parking and stopping zones on a path
(e and f are weighting values, and e+f=1)

6. The system according to claim 1, wherein the heatwave vulnerable class determination unit determines a heatwave vulnerable class by linking a temperature of each building and the heatwave risk of each building.

7. The system according to claim 6, wherein a temperature measured at a weather station nearest from a building is calculated as the temperature of each building.
